(19) United States
(12) Patent Application Publication
(10) Pub. No.: US 2006/0238020 A1
(43) Pub. Date: Oct. 26, 2006

(54) Vehicle brake control device

(76) Inventors: Chihiro Nitta, Kariya-city (JP); Takahisa Yokoyama, Kariya-city (JP); Haruo Arakawa, Kariya-city (JP); Takayuki Takeshita, Kariya-city (JP)

Correspondence Address: POSZ LAW GROUP, PLC, 12040 SOUTH LAKES DRIVE, SUITE 101, RESTON, VA, 20191, US

(21) Appl. No.: 11/403,000

(22) Filed: Apr. 13, 2006

(30) Foreign Application Priority Data
Apr. 21, 2005 (JP) 2005-123416

(51) Int. Cl. B60T 8/34

(52) U.S. Cl. 303/113.1; 303/167; 303/176

(57) ABSTRACT

A braking force reduction control that reduces the braking force applied to the vehicle wheels is performed when braking of the vehicle is detected. More specifically, the braking force reduction control is started when a speed change of the deceleration of the vehicle has a reducing tendency, namely, when the speed change is equal to or less than a predetermined threshold value.

### CROSS REFERENCE TO RELATED APPLICATION

This application is based upon and claims the benefit of Japanese Patent Application No. 2005-123416 filed on Apr. 21, 2005, the content of which are incorporated herein by reference.

### FIELD OF THE INVENTION

The present invention relates to a vehicle brake control device that can reduce forward and backward rocking of a vehicle that occurs when the vehicle stops, and that can also reduce shock that results from the rocking.

### BACKGROUND OF THE INVENTION

Japanese Patent Application Publication No. JP-A-H11-208439 and Japanese Examined Utility Model Application No. H6-8959 describe related devices that reduce forward-backward rocking of a vehicle that occurs when the vehicle stops and shock that results from this rocking.

The device described in JP-A-H11-208439 includes (i) means for detecting the braking state of the vehicle, (ii) means for detecting that the vehicle body corresponding to a sprung member has substantially stopped moving, (iii) a braking device that can control, when necessary, the braking force applied to the wheels regardless of the braking operation performed by the driver, and (iv) control means that, when the vehicle brakes, substantially cancels the braking force applied to the wheels after a predetermined period of time has elapsed from the moment the sprung member substantially stops moving.

Normally, the fact that a vehicle has stopped moving is detected based on a vehicle body speed calculated using detection signals from vehicle wheel speed sensors. When the vehicle body speed is zero, it is determined that the vehicle has stopped moving. In this configuration, the detection signals of the vehicle wheel speed sensors are pulse signals that are output in accordance with the rotation angles of the vehicle wheels. However, when the vehicle speed is low, the vehicle wheels rotate more slowly, and thus a substantial calculation delay occurs. As a result, it is not possible to accurately detect when the vehicle has stopped moving. In addition, if control of an anti-lock brake system (ABS) is performed, it is difficult to accurately detect when the vehicle has stopped moving because the vehicle wheels lock just before the vehicle stops moving.

In order to address the above problems, JP-A-H11-208439 proposes a device that is provided with a vehicle body-road speed sensor. The vehicle body-road speed sensor detects the vehicle body speed with respect to the road, and this detection result is used to detect whether the vehicle has stopped moving.

Alternatively, the device described in Japanese Examined Utility Model Application No. H6-8959 includes braking force reduction control means. The braking force reduction control means automatically reduces braking force after the vehicle speed has become equal to or less than a reference value, thereby allowing forward and backward rocking of the vehicle to be reduced when the vehicle stops. When it is determined that the driver is braking in an emergency, the device does not perform the braking force reduction control for reducing rocking.

However, the device described in JP-A-H11-208439 requires a vehicle body-ground speed sensor, which is not a component of a standard vehicle. As a result, the number of components in the vehicle is increased, and additional product processes are required for separately installing the vehicle body-road speed sensor. In addition, the vehicle body-road speed sensor is highly expensive and thus installing it leads to a substantial increase in costs.

Moreover, in the device described in Japanese Examined Utility Model Application No. H6-8959, the braking force reduction control is performed from before when the vehicle speed is completely zero. As a result, since the braking force reduction control starts too early, thus braking distance increases. Accordingly, the device does not perform braking force reduction control when the driver brakes in an emergency. However, with this configuration, when emergency braking is performed in ABS control or the like and there is substantial forward-backward rocking of the vehicle and resultant shock when the vehicle stops, the driver is subject to all of the shock.

### SUMMARY OF THE INVENTION

The present invention has been devised in light of the above circumstances and it is an object thereof to provide a vehicle brake control device that inhibits braking distance from increasing when a vehicle stops and that reduces forward and backward rocking of a vehicle body and resultant shock. To achieve this, the device uses a conventional sensor and optimally sets the start timing of braking force reduction control.

It is a further object of the invention to provide a vehicle brake control device that can optimally set the start timing of the braking force reduction control in order to avoid the braking distance of the vehicle increasing and to reduce forward-backward rocking of the vehicle body and resultant shock when the vehicle is stopped.

In order to achieve the above objects, according to a first aspect of the present invention, when a brake detection unit detects that the vehicle is braking, the brake control device performs a braking force reduction control that reduces the braking force applied to the vehicle wheels by a braking force control unit. The brake control device starts the braking force reduction control when a speed change of a deceleration of the vehicle is detected to have a reducing tendency by a speed change detection unit.

As a result of setting the braking force reduction control to start when the reducing tendency of the speed change is detected, it is possible to accurately detect when the vehicle has stopped moving. Accordingly, the braking force reduction control can be started at an optimal timing, which in turn inhibits the braking distance of the vehicle from increasing when the vehicle brakes, and reduces forward-backward rocking of the vehicle body and resultant shock. In addition, since the start timing of the braking force reduction control is determined based on the speed change of the deceleration as described above, the start timing can be set using an acceleration sensor which is conventionally provided in the vehicle.

According to the first aspect, the speed change detection unit may derive the speed change by differentiating the deceleration detected by the deceleration detection unit with respect to time.

A second aspect of the present invention is provided with an actual deceleration detection unit and a deceleration estimation unit. The actual deceleration detection unit detects an actual deceleration of the vehicle based on a detection signal from an acceleration sensor. The deceleration estimation unit derives an estimated deceleration, which is an estimated value for the deceleration of the vehicle, based on a received signal that corresponds with an operation amount of a brake operating member used to transmit a braking request of a driver. Further, the second aspect also includes a speed change detection unit that derives a speed change obtained based on the difference between the estimated deceleration obtained by the deceleration estimation unit and the actual deceleration obtained by the actual deceleration detection unit. When the brake detection unit detects that the vehicle is braking, the brake control device performs a braking force reduction control that reduces the braking force applied to the vehicle wheels by the braking force control unit. The brake control device starts the braking force reduction control when the speed change detected by the speed change detection unit is detected to have a reducing tendency.

As described above, the start timing of the braking force reduction control is determined based on differentiation of the difference between the estimate deceleration and the actual deceleration with respect to time. With this configuration, the actual deceleration starts to decease at the moment that the actual body speed becomes zero. However, even if the actual vehicle body speed has become zero, the estimated deceleration does not start to reduce until the depression force starts to reduce. Thus, a difference is generated between the actual deceleration and the estimated deceleration. As a result, it is possible to accurately detect when the vehicle has stopped moving based on the speed change. More specifically, it is possible to detect that the vehicle has stopped based on when the speed change becomes equal to or less than a threshold value. Accordingly, stopping of the vehicle can be detected with almost no delay from the time when the vehicle actually stops moving.

According to the second aspect, the speed change detection unit may derive the speed change by differentiating the difference between the estimated deceleration and the actual deceleration with respect to time.

Further, the first aspect may be provided with a vehicle body speed detection unit that derives a vehicle body speed of the vehicle. With this configuration, the brake control device only performs the braking force reduction control when the vehicle body speed is equal to or less than a predetermined threshold value.

With the above configuration, the braking force reduction control is only started when the vehicle body speed is equal to or below the predetermined vehicle speed. As a result, it is possible to inhibit the braking force reduction control from starting mistakenly if the road surface friction coefficient μ changes.

According to a third aspect of the present invention, a vehicle brake control device is provided with a vehicle body speed detection unit that derives a vehicle body speed of the vehicle; and an emergency braking determination unit that determines whether the vehicle is braking in an emergency. In the case that the emergency braking determination unit determines that the vehicle is braking in an emergency, the brake control device performs the braking force reduction control described in the first aspect as a post-stopping braking force control. Further, in the case that the emergency braking determination unit determines that the vehicle is braking in a non-emergency situation, the brake control device performs the braking force reduction control as a pre-stopping braking force control when the vehicle body speed detected by the vehicle body speed detection unit is equal to or less than a predetermined value.

With the above configuration, shortening of the braking distance can be prioritized during emergency braking under ABS control or the like. On the other hand, reduction of forward-backward rocking of the vehicle and resultant shock can be prioritized when braking in non-emergency situations.

### BRIEF DESCRIPTION OF THE DRAWINGS

Other objects, features and advantages of the present invention will be understood more fully from the following detailed description made with reference to the accompanying drawings. In the drawings:

FIG. 1 shows an overall block diagram of a vehicle brake control device according to a first embodiment of the invention;

FIG. 2 is a flow chart of a braking force reduction control process performed by a brake ECU in the vehicle brake control device of FIG. 1;

FIG. 3 is a timing chart illustrating the relationship of a vehicle body speed V, a deceleration G, a speed change Gd of the deceleration G, and a braking force Fb applied to wheels when the braking force reduction control process is not performed;

FIG. 4 is a timing chart illustrating the relationship of the vehicle body speed V, the deceleration G, the speed change Gd of the deceleration G, and the braking force Fb applied to the wheels when braking force reduction control process is performed;

FIG. 5 is a timing chart showing the deceleration G and its speed change Gd in the cases that the driver intentionally eases depression of a brake pedal, and the vehicle has stopped moving;

FIG. 6 is a flow chart of a braking force reduction control process performed by the brake ECU provided in the vehicle brake control device of a second embodiment of the invention;

FIG. 7 is a timing chart illustrating the relationship of the vehicle body speed V, the deceleration G, speed change (Gt−G)d of the deceleration G, and the braking force Fb applied to the wheels when the driver increases the depression force of the brake pedal just before the vehicle stops moving;

FIG. 8 is a flow chart of a braking force control switching process that is performed by the brake ECU provided in the vehicle brake control device according to a third embodiment of the invention;

FIG. 9 is a flow chart of a braking force reduction control process performed by the brake ECU provided in the vehicle brake control device according to a fourth embodiment of the invention; and

FIG. 10 is a flow chart of a braking force reduction control process performed by the brake ECU provided in the vehicle brake control device according to a fifth embodiment of the invention.

### DETAILED DESCRIPTION OF THE PREFERRED EMBODIMENTS

The present invention will be described further with reference to various embodiments in the drawings.

### First Embodiment

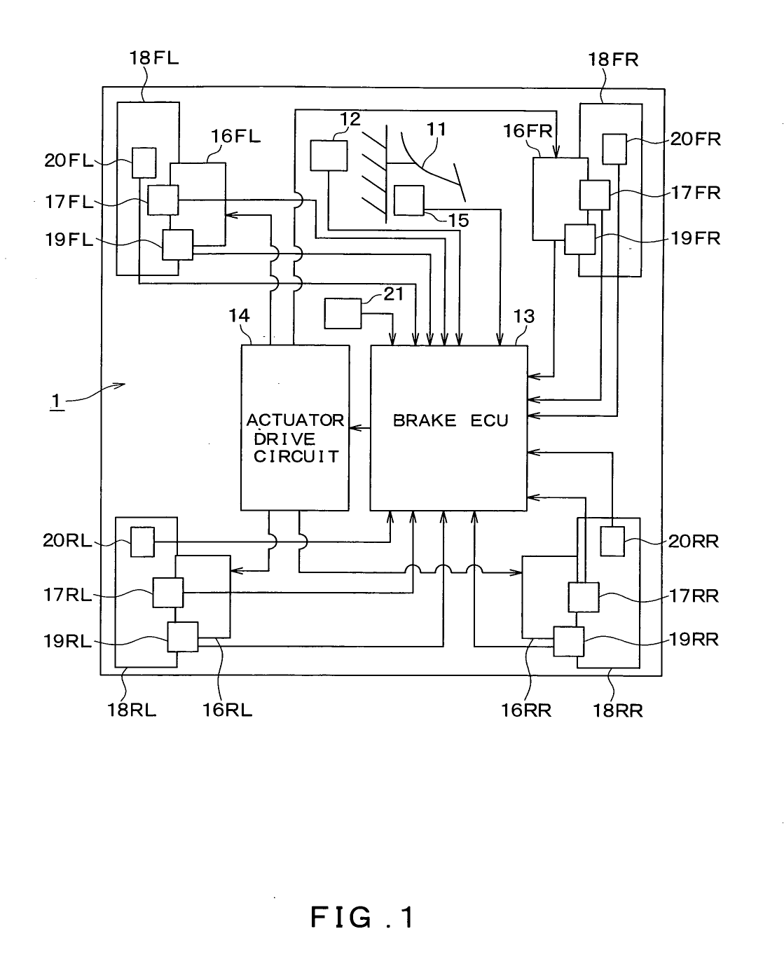

FIG. 1 shows an overall block diagram of a vehicle brake control device 1 according to a first embodiment. Hereinafter, the configuration of the vehicle brake control device 1 of the present embodiment will be described with reference to FIG. 1.

Referring to FIG. 1, the vehicle brake control device 1 includes a brake pedal 11; a depression force sensor 12; a brake control unit (hereinafter “brake ECU”) 13; an actuator drive circuit 14; a brake pedal switch 15; actuators 16FL, 16FR, 16RL and 16RR; wheel cylinders 17FL, 17FR, 17RL and 17RR; clamping force sensors 19FL, 19FR, 19RL and 19RR; vehicle wheel speed sensors 20FL, 20FR, 20RL and 20RR; and acceleration sensor 21.

The brake pedal 11 functions as a brake operation member, and is connected to a stroke simulator (not specifically shown). When the brake pedal 11 is depressed by the driver, a brake fluid pressure that corresponds to the brake pedal depression amount is generated in the stroke simulator.

The depression force sensor 12 detects the depression force when the brake pedal 11 is depressed, and outputs a detection signal that corresponds to the operation amount of the brake pedal 11. This detection signal is input to the brake ECU 13.

The brake ECU 13 is configured from a known micro-computer that includes a CPU, a ROM, a RAM, an I/O port etc. The brake ECU 13 performs various types of processing such as a stop control process in accordance with programs stored in the ROM etc. The brake ECU 13 receives the detection signal from the depression force sensor 12 and also detection signals from the brake pedal switch 15, the vehicle wheel speed sensors 20FL to 20RR, and the acceleration sensor 21. The brake ECU 13 uses these signals to perform calculation processing for performing various types of processing including the stop control process, and outputs a control signal based on the calculation results to an actuator drive circuit 14 in order to drive the actuators 16FL to 16RR.

The actuator drive circuit 14 drives the actuators 16FL to 16RR based on the control signal received from the brake ECU 13, thus controlling the braking force applied to the vehicle wheels 18FL, 18FR, 18RL and 18RR.

The brake pedal switch 15 detects whether the brake pedal 11 is depressed, and outputs a detection signal corresponding to the detection result. The detection signal of the brake pedal switch 15 is input to the brake ECU 13. Accordingly, the brake ECU 13 can detect whether the vehicle is braking based on the detection signal of brake pedal switch 15.

The actuators 16FL to 16RR correspond to a braking force generating unit. The structure of each actuator 16FL to 16RR provided for each wheel 18FL to 18RR is fundamentally the same. More specifically, the actuators 16FL to 16RR include a motor, a rotational-linear movement conversion unit, and a master cylinder (not shown).

The motor is driven by the actuator drive circuit 14, and has a rotating output shaft that performs a desired rotational movement in accordance with a request from the actuator drive circuit 14. The rotational-linear movement conversion unit converts the rotational movement of the motor to linear movement. The rotational-linear movement conversion unit operationally couples the rotating output shaft of the motor and the reciprocating piston of the master cylinder. The master cylinder generates a control oil pressure using the reciprocating movement of the piston that is generated from the rotational movement of the motor transmitted as linear movement by the rotational-linear movement conversion unit. The master cylinder is hydraulically connected to the wheel cylinders 17FL, 17FR, 17RL and 17RR that correspond to the actuators 16FL to 16RR. The control oil pressure generated in the master cylinder is supplied to each vehicle wheel cylinder 17FL to 17RR.

The control oil pressure generated by the actuators 16FL to 16RR is applied to the wheel cylinders 17FL to 17RR, whereby respective brake pads provided in the calipers in the vehicle wheels 18FL to 18RR are pushed against the respective disk rotors, not shown, to generate braking force that brakes the vehicle wheels 18FL to 18RR The clamping force sensors 19FL to 19RR detect the force at which each brake pad is pushed against the respective disk rotor, or in other words, the pressing force generated by the wheel cylinders 17FL to 17RR. The detection signals of the clamping force sensors 19FL to 19RR are also input to the brake ECU 13. The brake ECU 13 uses the detection signals to derive the pressing force generated by the wheel cylinders 17FL to 17RR, and uses this information to perform feedback control of the braking force applied to the vehicle wheels 18FL to 18RR.

The vehicle wheel speed sensors 20FL to 20RR are located in the corresponding vehicle wheels 18FL to 18RR. The speed sensors 20FL to 20RR output respective pulse signals with pulse numbers that are proportional to the respective rotation speeds of the vehicle wheels 18FL to 18RR, namely, the vehicle wheel speeds, to the brake ECU 13. The brake ECU 13 uses the detection signals from the vehicle wheel speed sensors 20FL to 20RR to derive the vehicle wheel speed of each vehicle wheel 18FL to 18RR and the vehicle speed (estimated vehicle body speed), and then uses the derived vehicle wheel and vehicle speeds to perform ABS control and the like. Note that, the brake ECU 13 uses a known method to calculate the vehicle speed and thus a description of this method will be omitted here.

The acceleration sensor 21 is positioned at a appropriate position in the vehicle body, and detects the forward or backward acceleration of the vehicle. The detection signal of the acceleration sensor 21 is also input to the brake ECU 13, which uses the detection signal to derive the forward or backward acceleration of the vehicle.

This completes the description of the structure of the vehicle brake control device 1 of the present embodiment. Next, the operation of the vehicle brake control device 1 will be explained.

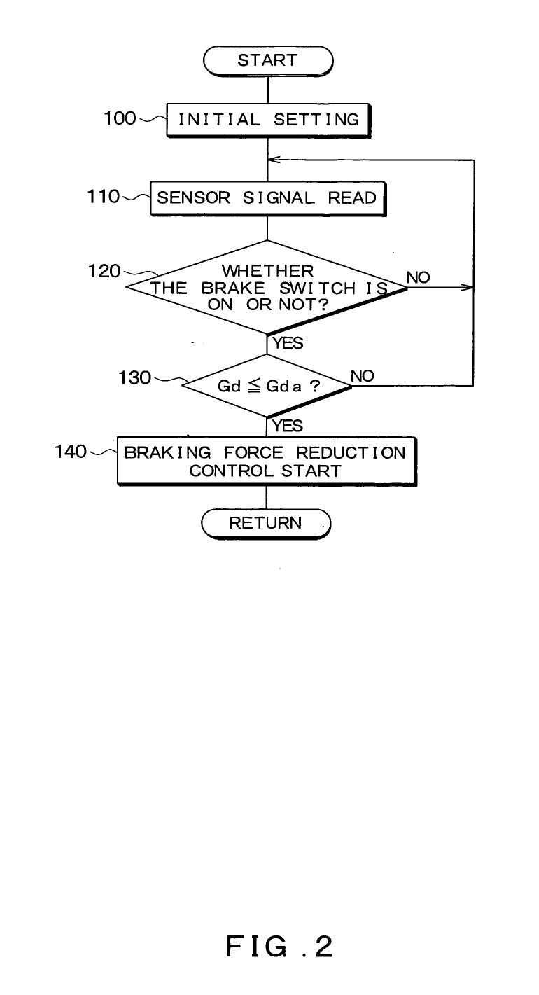

FIG. 2 is a flow chart of a braking force reduction control process performed by the brake ECU 13 in the vehicle brake control device 1. The process shown in the figure is repeatedly performed at a predetermined time interval when, for example, an ignition switch, not shown, is turned on.

First, in the processing at 100, initial setting is performed, which includes resetting the various values stored in the memory of the brake ECU 13. Then, in the processing at 110, the values output from the various sensors are read. More particularly, the detection signals from the depression force sensor 12, the brake pedal switch 15, the vehicle wheel speed sensors 20FL to 20RR, and the acceleration sensor 21 are input. Then, the brake ECU 13 uses the various detection signals to determine (i) the depression force value, (ii) whether the brake pedal 11 is depressed or not, (iii) the vehicle wheel speeds of the vehicle wheels 18FL to 18RR, and (iv) the rate of acceleration of the vehicle in the forward or backward direction. Note that, the portion of the brake ECU 13 that performs this processing corresponds to a deceleration detection unit (actual deceleration detection unit) and a vehicle body speed detection unit.

Next, in the processing at 120, it is determined whether the brake switch is ON or not. This processing is performed based on the sensor values read in the processing at 110, namely, whether or not the brake pedal 11 is depressed, which is determined based on the detection signal from the brake pedal switch 15. If the determination result is YES, it is determined that it may be necessary to perform stop control and thus the routine proceeds to the processing at 130. On the other hand, if the determination result is NO, it is determined that it is not necessary to perform stop control, and the processing at 110 is performed again. Note that, the portion of the brake ECU 13 that perform this processing corresponds to a brake detection unit.

In the processing at 130, it is determined whether the speed change Gd of the deceleration G is equal to or less than a predetermined threshold value Gda. Note that the deceleration G corresponds to the rate of acceleration of the vehicle in the backward direction, and is derived from the rate of acceleration obtained at 110 based on the detection signal from the acceleration sensor 21. More specifically, if the rate of acceleration derived from the detection signal of the acceleration sensor 21 is positive, the vehicle is taken to be moving in an acceleration direction, and if the detection signal is negative the vehicle is taken to be moving in a deceleration direction. Accordingly, the rate of acceleration when the detection value is negative is taken to be the deceleration G. In addition, the deceleration G is differentiated with respect to time to derive the speed change Gd. Note that, the portion of the brake ECU 13 that performs this processing corresponds to a speed change detection unit.

If the determination result at 130 is YES, the routine proceeds to the processing at 140 where the braking force reduction control is started. However, if the determination result is NO, it is taken that the braking force reduction control does not yet need to be performed, and the routine returns to 110. Note that, the control method used for the braking force reduction control is the same as that disclosed in JP-A-H11-208439 and Japanese Examined Utility Model Application No. H6-8959. In the processing at 140, the brake ECU 13 outputs a control signal to the actuator drive circuit 14 that causes the braking force applied to the vehicle wheels 18FL to 18RR by the actuators 16FL to 16RR to reduce to zero.

As a result, the suspension's reaction force acts to move the vehicle wheels 18FL to 18RR relatively forward with respect to the vehicle body, which thus inhibits forward-backward rocking of the vehicle body and resultant shock.

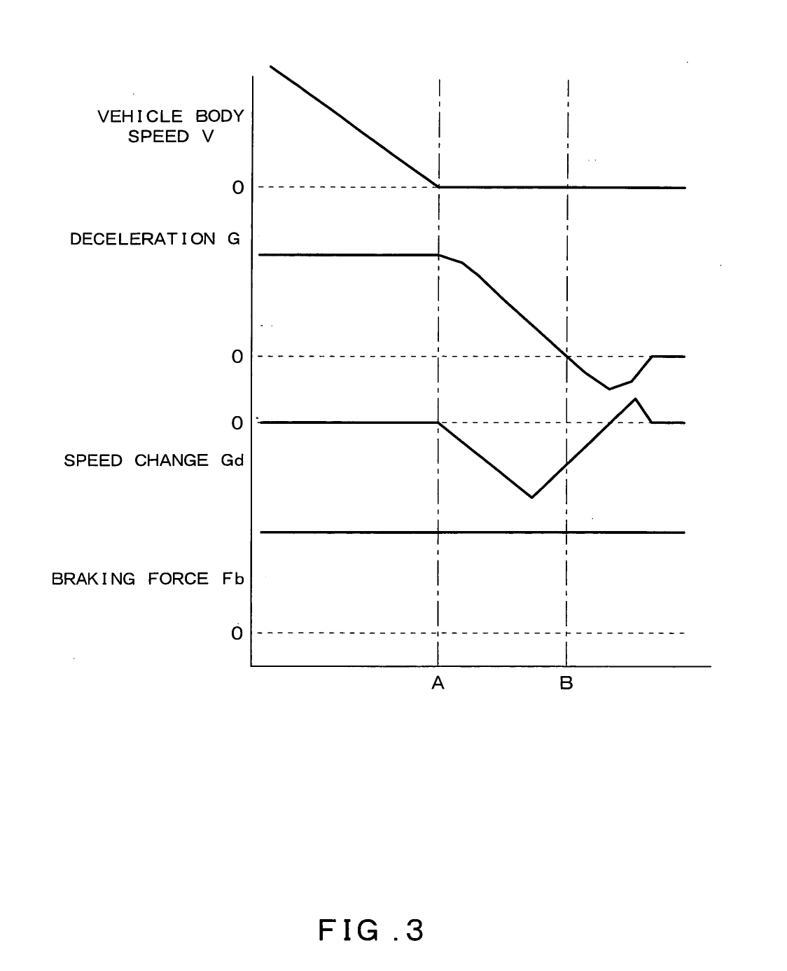

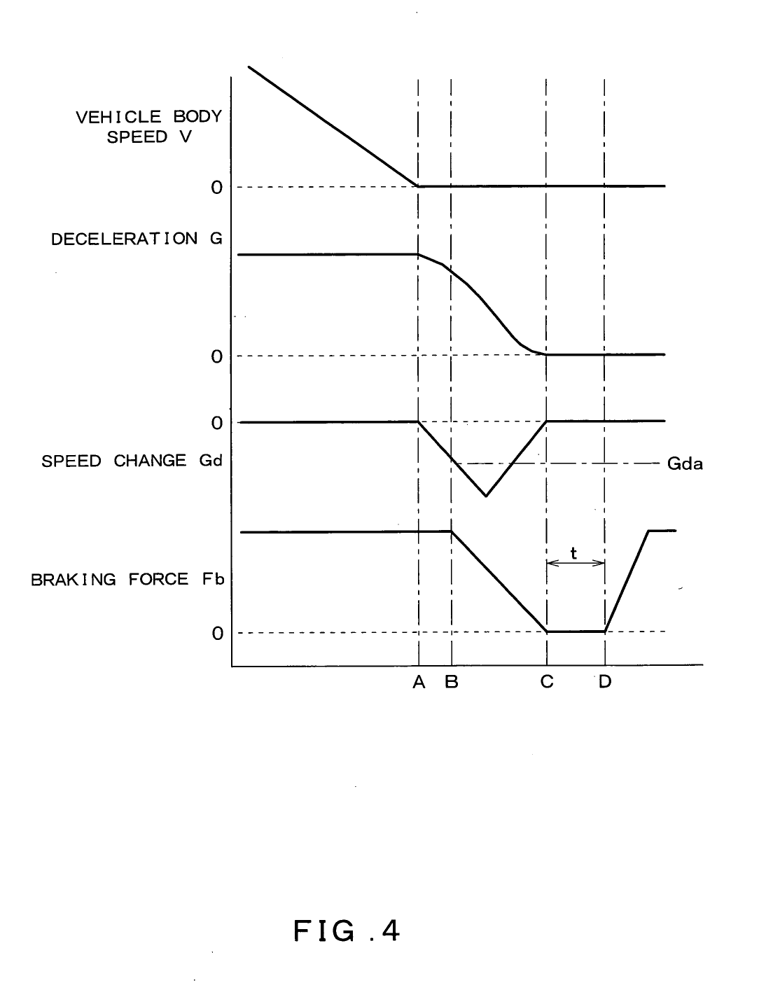

Next, FIGS. 3 and 4 will be used to explain the effects obtained when the above braking force reduction control process is performed.

FIGS. 3 and 4 are timing charts illustrating the relationship of the vehicle body speed V, the deceleration G, the speed change Gd of the deceleration G, and the braking force Fb applied to vehicle wheels 18FL to 18RR when the braking force reduction control process is not performed (FIG. 3) or performed (FIG. 4).

In FIG. 3, at first, the vehicle is decelerating with the deceleration G at a constant. Then, at time A, the vehicle stops moving, or in other words, the vehicle body has moved as far forward as possible with respect to the vehicle wheels 18FL to 18RR. From this moment onwards, the deceleration G begins to decrease. Then, the deceleration G gradually continues to decrease, and first becomes a negative value when time B has passed. As a result of this, rocking and resultant shock of the vehicle are generated, and the heads of the driver and any other vehicle occupant are forcibly knocked against the headrests.

To address this, in this embodiment, the fact that the deceleration G has started to reduce is detected based on the speed change Gd of the deceleration G. Then, the braking force reduction control is set to start at a timing during the period from (i) when the speed change Gd becomes equal to or less than the predetermined threshold value Gda, namely, when the vehicle body speed V has become exactly zero, until (ii) when rocking starts to occur.

More specifically, as shown in FIG. 4, the deceleration G begins to decrease at the moment the vehicle stops moving at time A. Accordingly, the speed change Gd of the deceleration G starts to decrease. At this time, the speed change Gd of the deceleration G has a negative value since the deceleration G is reducing. Further, when the speed change Gd of the deceleration G becomes equal to or less than the predetermined threshold value Gda at time B, this moment is taken as the start timing for the braking force reduction control. Accordingly, the braking force reduction control is started, whereby the braking force Fb applied to the vehicle wheels 18FL to 18RR is reduced.

As a result, the decrease in the deceleration G gradually lessens until the deceleration G becomes zero at time C. After time C, the deceleration G remains substantially unchanged. The braking force reduction control is continued for just a selected time t after time C, and then at time D the braking force reduction control is terminated. At that point, braking force is once again applied to the vehicle wheels 18FL to 18RR.

Performing the braking force reduction control process in this manner makes it possible to accurately detect when the vehicle has stopped moving, thus allowing the start timing of braking force reduction control to be set optimally. Accordingly, it is possible to inhibit the braking distance of the vehicle from increasing when the vehicle stops, and reduce forward-backward rocking of the vehicle body and resultant shock. Further, since the start timing of the braking force reduction control is determined based on the speed change Gd of the deceleration G, the start timing can be set using the acceleration sensor 21 which is conventionally provided in the vehicle.

Further, after forward-backward rocking of the vehicle body and resultant shock has been reduced by performing the braking force reduction control, braking force is once again applied to the vehicle wheels 18FL to 18RR, whereby the vehicle is inhibited from moving. Note that, in the example described above, the braking force reduction control is continued for just the selected time t. However, the selected time t need not be set, and instead braking force may be applied to the vehicle wheels 18FL to 18RR again at the moment when the deceleration G becomes zero, namely, at the moment when the speed change Gd of the deceleration returns to zero.

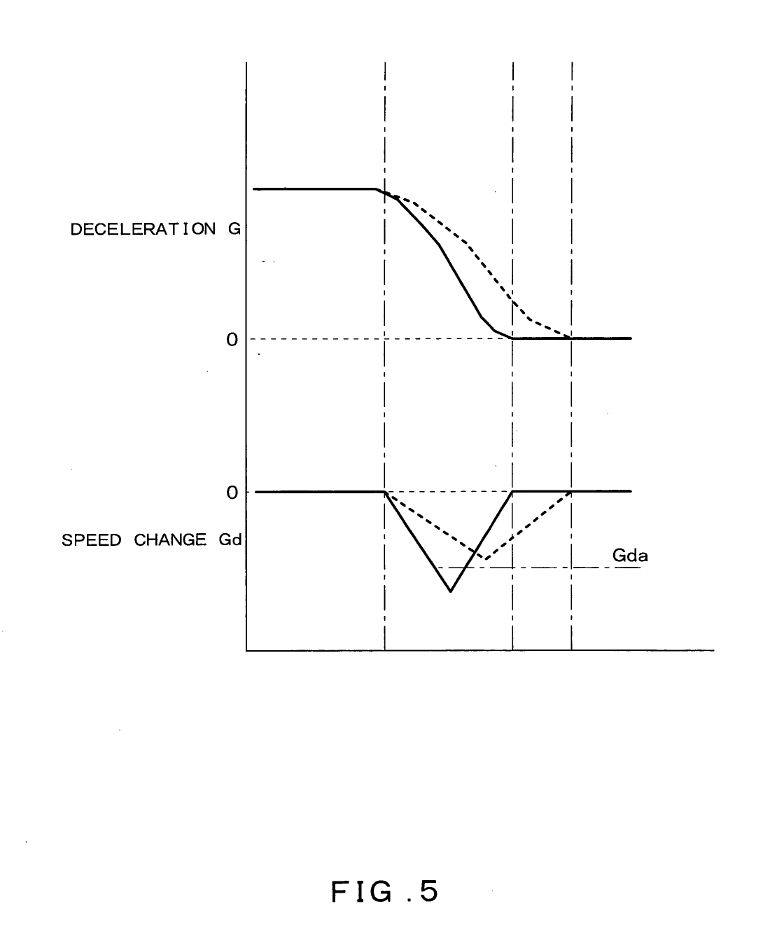

Note that, it is possible that the driver will ease depression of the brake pedal 11 during braking. The dotted lines in FIG. 5 show the changes in the deceleration G and the speed change Gd thereof in this situation.

Referring to FIG. 5, the deceleration G reduces even in the case that the driver intentionally eases the depression of the brake pedal 11. Given this fact, the speed change Gd of the deceleration G will of course be a negative value. However, as will be apparent from comparison of the deceleration G and the speed change Gd at the moment when the vehicle stops moving in the two different cases (as shown by the solid and dotted lines in FIG. 5), the hypothesized speed change Gd for when the driver intentionally eases depression of the brake pedal 11 is comparatively larger than the speed change Gd at the moment when the vehicle stops.

As a result, it is preferable that the predetermined threshold value Gda is set smaller than the hypothesized speed change Gd for when the driver intentionally eases the brake pedal 11, and set to be larger than the hypothesized speed change Gd for the moment when the vehicle stops moving. As a result of performing setting in this manner, it is possible to prevent the braking force reduction control from being mistakenly started at times when the driver intentionally eases depression of the brake pedal 11.

### Second Embodiment

Next, a second embodiment of the invention will be explained. In this embodiment, the specific details of the braking force reduction control process performed by the brake ECU 13 are different to that of the first embodiment. However, all other structural features of the second embodiment are the same as those of the first embodiment. Accordingly, the explanation given here will not repeat the explanation of these structural features and will instead focus on those features that are different to the first embodiment.

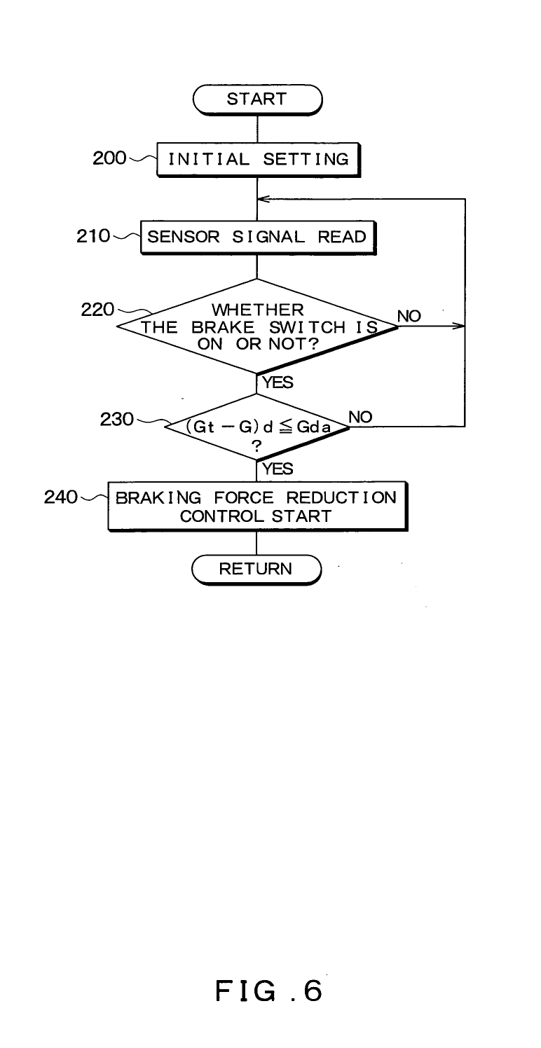

FIG. 6 is a flow chart of the braking force reduction control process performed by the brake ECU 13 provided in the vehicle brake control device 1 of the second embodiment. The braking force reduction control process is repeatedly performed at a predetermined time interval when, for example, the ignition switch is turned on.

First, in the processing at 200 to 220, the brake ECU 13 performs the same processing as at 100 to 120 of the first embodiment. Then, at 230, the difference is obtained between an estimated deceleration Gt that is estimated based on the depression force with which the driver depresses the brake pedal 11, and the deceleration G (namely, the actual deceleration) derived from the detection signal from the acceleration sensor 21. This difference is differentiated with respect to time to obtain a speed change (Gt−G)d. Note that, the estimated deceleration Gt estimated from the depression force of the brake pedal 11 is derived using a depression force that is derived from the detection result of the depression force sensor 12 input in the processing at 210. More specifically, the deceleration Gt is derived by calculation or by using a map showing the correlation between the depression force and the deceleration that is pre-stored in the ROM of the brake ECU 13. Note that, the portion of the brake ECU 13 that performs the above processing corresponds to a deceleration estimation unit and a speed change detection unit.

Next, in the processing at 230, it is determined whether the derived speed change (Gt−G)d is equal to or less than the predetermined threshold value Gda. If the determination result is YES, the routine proceeds to the processing at 24D where the braking force reduction control is started. More specifically, the brake ECU 13 outputs a control signal to the actuator drive circuit 14 that causes the braking force applied to the vehicle wheels 18FL to 18RR by the actuators 16FL to 16RR to reduce to zero. On the other hand, if the determination result at 240 is NO, it is taken that the braking force reduction control does not yet need to be performed, and the routine returns to 210.

In the case that the processing at 240 is performed, the suspension's reaction force acts to move the vehicle wheels 18FL to 18RR relatively forward with respect to the vehicle body, which thus inhibits forward-backward rocking of the vehicle body and resultant shock.

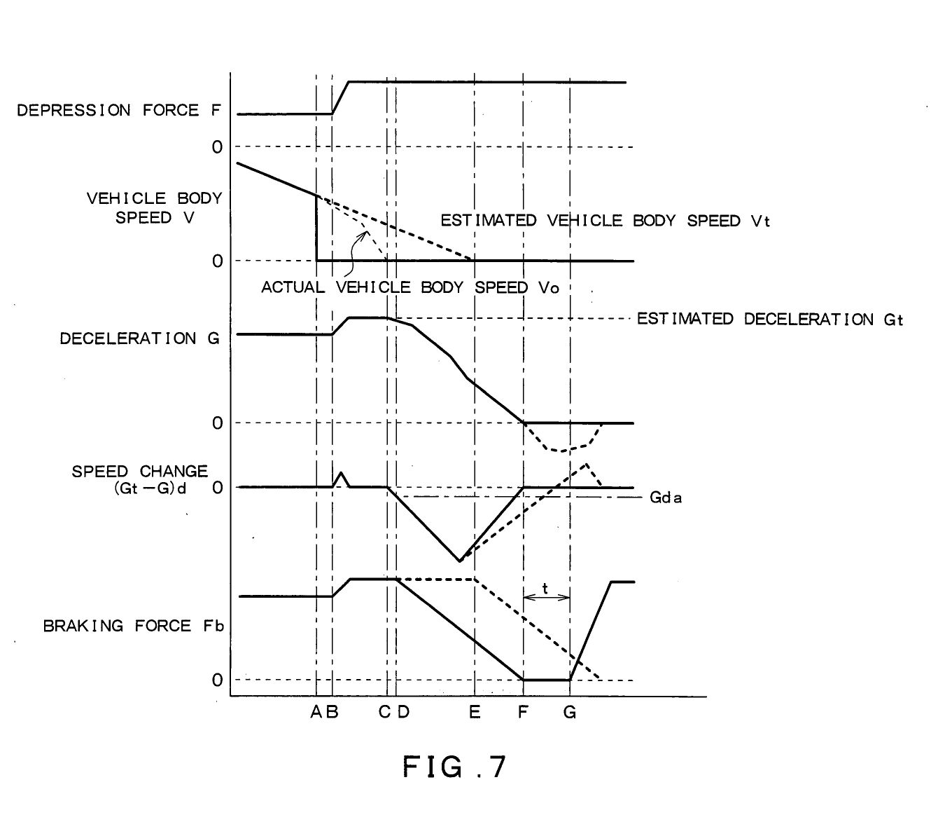

When the above described braking force reduction control process is performed, the following effects can be obtained. These effects will be explained with reference to FIG. 7.

FIG. 7 is a timing chart for a case when the braking force reduction control process of the present embodiment is performed. More specifically, the timing chart illustrates the relationship of the vehicle body speed V, the deceleration G, speed change (Gt−G)d, and the braking force Fb applied to the wheels 18FL to 18RR when the driver increases the depression force of the brake pedal 11 just before the vehicle stops moving.

The vehicle body speed V is derived by calculation using a known method based on the vehicle wheel speeds obtained from the detection signals from the vehicle wheel speed sensors 20FL to 20RR. However, in cases where there is substantial delay in calculating the vehicle wheel speeds such as just before the vehicle stops moving, an estimated vehicle body speed Vt, which is estimated from the pre-derived vehicle body speed V, is used as the vehicle body speed V. For example, it is normal to use the estimated vehicle body speed Vt as the vehicle body speed V after time A shown in FIG. 7.

In a situation like that described above, if the driver increases braking force at time B, which is after time A, an actual vehicle body speed Vo decreases in the manner illustrated by the thin dotted line in FIG. 7. As a result, the actual deceleration G starts to decrease at the same time as the actual vehicle speed Vo becomes zero. However, since the estimated vehicle body speed Vt has not become zero, the brake ECU 13 does not determine that the vehicle has stopped moving.

Accordingly, the brake ECU 13 only determines that the vehicle has stopped moving at time E when the estimated vehicle body speed Vt becomes zero. Thus, this time is taken as the start timing for the braking force reduction control. However, this timing deviates substantially from the actual moment when the vehicle stops moving. As a result, the start timing of the braking force reduction control is late, and thus the braking force reduction control is performed as indicated by the dotted lines in FIG. 7. When time F has passed, the deceleration G becomes a negative value for the first time, which causes rocking and resultant shock.

In contrast to this, in the present embodiment, the start timing for the braking force reduction control is determined using the speed change (Gt−G)d obtained by differentiating the difference of the estimated deceleration Gt and the actual deceleration G with respect to time. With this configuration, the actual deceleration G starts to decrease at the moment the actual vehicle body speed Vo becomes zero. However, even if the actual vehicle body speed Vo has become zero, the estimated deceleration Gt does not start to decrease until the depression force (F) decreases. Accordingly, a difference is generated between the actual deceleration G and the estimated deceleration Gt. Accordingly, stopping of the vehicle can be accurately detected based on the speed change (Gt−G)d. More specifically, in this example, stopping of the vehicle is detected at time D when the speed change (Gt−G)d has become equal to or less than the threshold value Gda. Thus, stopping of the vehicle can be detected with almost no delay from the time when the vehicle actually stops moving.

Therefore, the braking force reduction control can be performed from time D when it is detected that the vehicle has stopped moving, and the start timing of the braking force reduction control can be set optimally. As a result, the braking distance of the vehicle is inhibited from increasing when the vehicle stops, and forward and backward rocking of the vehicle body and resultant shock are reduced. In addition, because the start timing of the braking force reduction control is determined based on the speed change (Gt−G)d obtained by differentiating the difference between the estimated deceleration G and the actual deceleration G with respect to time in the above described manner, the start timing can be set using the acceleration sensor 21 which is conventionally provided in the vehicle.

### Third Embodiment

Next, a third embodiment of the present invention will be described. This embodiment utilizes both (a) a post-stopping braking force control that is performed after the vehicle has stopped like the braking force reduction control process described in the first and second embodiments, and (b) a pre-stopping braking force control that is performed before the time when the vehicle completely stops like the braking force reduction control process described in Japanese Examined Utility Model Application No. H6-8959. Note that, the specific methods used for the post-stopping braking force control and the pre-stopping braking force control are the same as those described in the first and second embodiments and in Japanese Examined Utility Model Application No. H6-8959. Accordingly, the explanation provided here will focus on how switching between the two controls is performed, and a specific description of the controls will be omitted.

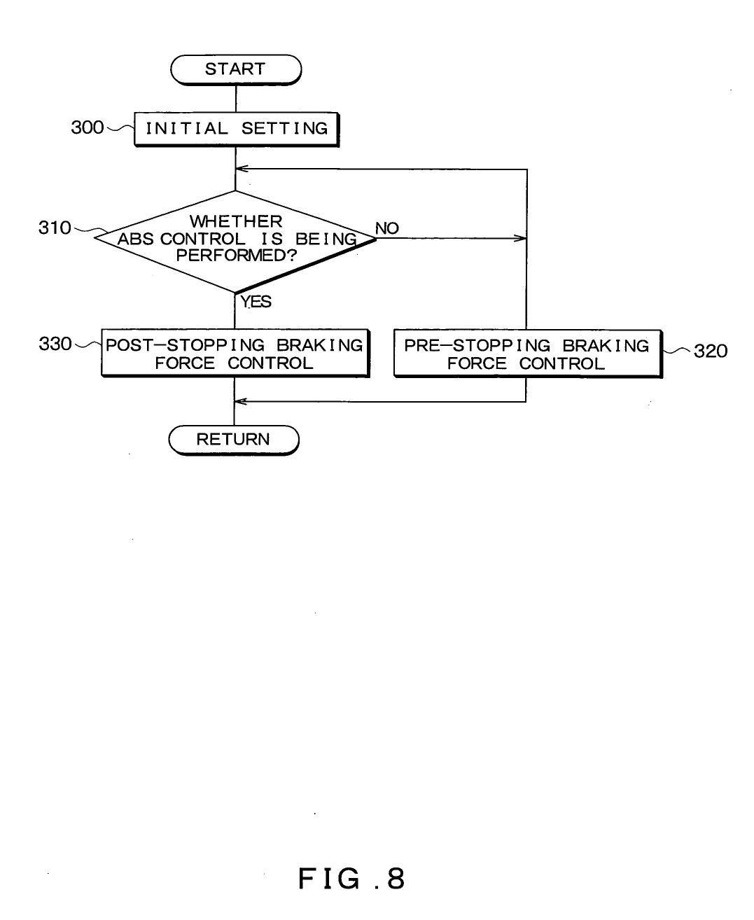

FIG. 8 is a flow chart showing the details of a braking force control switching process that is performed by the vehicle brake control device 1 according to the present embodiment. The process shown in the figure is repeatedly performed at a predetermined time interval when, for example, an ignition switch, not shown, is turned on. This process determines which one of the post-stopping braking force control and the pre-stopping braking force control is performed, and then sets the appropriate control. The set braking force reduction control process, which is described in the first and second embodiments or in Japanese Examined Utility Model Application No. H6-8959, is then performed.

First, in the processing at 300, initial setting is performed in the same manner as at 100 described above. Then, the routine proceeds to the processing at 310 where it is determined if ABS control is being performed. This determination is based on whether an ABS control flag is set. The ABS control flag is set in an ABS control routine that is performed separately from the control routine of the brake ECU 13. The ABS control flag is set, for example, when a slip ratio exceeds a start threshold value for the ABS control. This slip ratio indicates the difference between the vehicle wheel speeds of the vehicle wheels 18FL to 18RR derived from the detection signals of the vehicle wheel speed sensors 20FL to 20RR during braking, and the estimated vehicle body speed derived from the vehicle wheel speeds. Accordingly, a predetermined region of the RAM or the like in the brake ECU 13 can be read to determine whether the ABS control flag is set, or in other words, to determine whether the ABS control is being performed.

If the determination result of the processing at 310 is NO, the routine proceeds to the processing at 320 where the pre-stopping braking force control is set. On the other hand, if the determination result is YES, the routine proceeds to the processing at 330 where the post-stopping braking force control is set. In this manner, the brake ECU 13 switches between performance of the pre-stopping braking force control and the post-stopping braking force control.

If the pre-stopping braking force control is set, the braking force reduction control is started from the time when the vehicle body speed V becomes equal to or less than a predetermined reference value in the same manner as in Japanese Examined Utility Model Application No. H6-8959. On the other hand, if the post-stopping braking control is set, the braking force reduction control is started at the time when the speed change Gd of the deceleration G is equal to or less the predetermined threshold value Gda as in the first embodiment, or at the time when the speed change (Gt−G)d (which is obtained by differentiating the difference of the estimated deceleration Gt and the actual deceleration G with respect to time) is equal to or less than the threshold value Gda as in the second embodiment.

When the pre-stopping braking force control is set, the braking distance is longer than when the post-stopping braking force control is set. However, since the braking force reduction control starts earlier, it is possible to reduce forward-backward rocking and resultant shock more. On the other hand, when the post-stopping braking force control is set, in contrast to when the pre-stopping braking force control is set, the braking force reduction control does not start until the vehicle stops. Accordingly, although there is a possibility that forward-backward rocking and resultant shock will increase slightly, the braking distance will be reduced to this extent.

With the configuration of the above control, shortening of braking distance can be prioritized when the vehicle brakes in an emergency under ABS control or the like. On the other hand, reduction of forward-backward rocking and resultant shock can be prioritized when braking is performed in non-emergency situations.

### Fourth Embodiment

Next, a fourth embodiment of the invention will be explained. In this embodiment, in contrast to the first embodiment, the braking force reduction control is only performed when the vehicle body speed V is equal to or less than a predetermined speed. Accordingly, the specific details of the braking force reduction control performed by the brake ECU 13 in this embodiment are different to that of the first embodiment. However, all other structural features of the fourth embodiment are the same as those of the first embodiment. Accordingly, the explanation given here will not repeat the explanation of these structural features and will instead focus on those features that are different to those of the first embodiment.

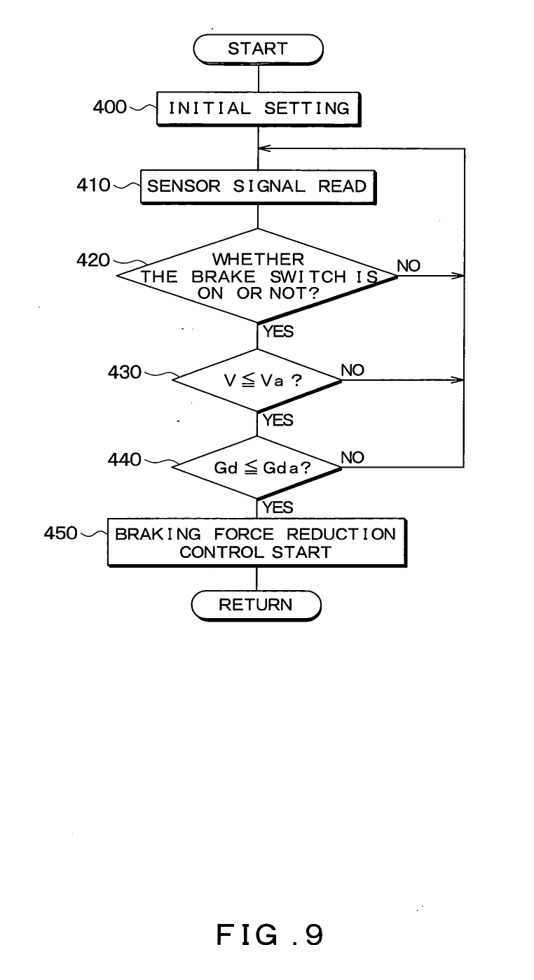

FIG. 9 is a flow chart of the braking force reduction control process performed by the brake ECU 13 provided in the vehicle brake control device 1 according to the present embodiment. The braking force reduction control process is repeatedly performed at a predetermined time interval when, for example, the ignition switch, not shown, is turned on.

First, in the processing at 400 to 420, the brake ECU 13 performs the same processing as at 100 to 120 of the first embodiment. Then, in the processing at 430, it is determined whether the vehicle body speed V is equal to or below a predetermined speed Va. Here, in the case that the vehicle speed V used is calculated based on the vehicle wheel speeds obtained from the detection signals from the vehicle wheel speed sensors 20FL to 20RR, the predetermined speed Va is set at the detectable limit of the vehicle body speed V, namely, around two km/h, for example. However, if the estimated vehicle body speed estimated in advance from the vehicle body speed V is used for the vehicle body speed V, the predetermined speed Va may be set to zero km/h.

Next, in the processing at 440, it is determined whether the speed change Gd of the deceleration G is equal to or less than a predetermined threshold value Gda, as in the processing at 130 of the first embodiment. Then, if the determination result is YES, the routine proceeds to the processing at 450, where the brake control reduction control is performed in the same manner as at 140 of the first embodiment. Note that, the routine only proceeds to the processing at 450 when the determination result is YES.

As will be clear from the above description, the braking force reduction control is only performed when the vehicle body speed V is equal to or less than the predetermined vehicle speed Va. As a result, the following effects can be obtained.

If the friction coefficient μ of the road surface that the vehicle is running along changes from a high value (high μ) to a low value (low μ) during braking, the resultant deceleration G becomes smaller. Accordingly, when the road surface friction coefficient μ changes in this manner, the speed change Gd of the deceleration G becomes equal to or less than the predetermined threshold valve Gd. As a result, the braking force reduction control may be mistakenly started.

To address this problem, if the braking force reduction control is only started when the vehicle body speed V is equal to or less than the predetermined speed Va as in the fourth embodiment, it is possible to inhibit the braking force reduction control from being started mistakenly if the road surface friction coefficient μ changes.

### Fifth Embodiment

Now, a fifth embodiment of the present invention will be described. In this embodiment, in contrast to the second embodiment, the braking force reduction control is only performed when the vehicle body speed V is equal to or less than a predetermined speed as in the fourth embodiment. Accordingly, the fifth embodiment differs from the second embodiment with respect to the specific details of the braking force reduction control performed by the brake ECU 13. However, all other structural features of the fifth embodiment are the same as those of the second embodiment. Accordingly, the explanation given here will not repeat the explanation of these structural features and will instead focus on those features that are different to those of the second embodiment.

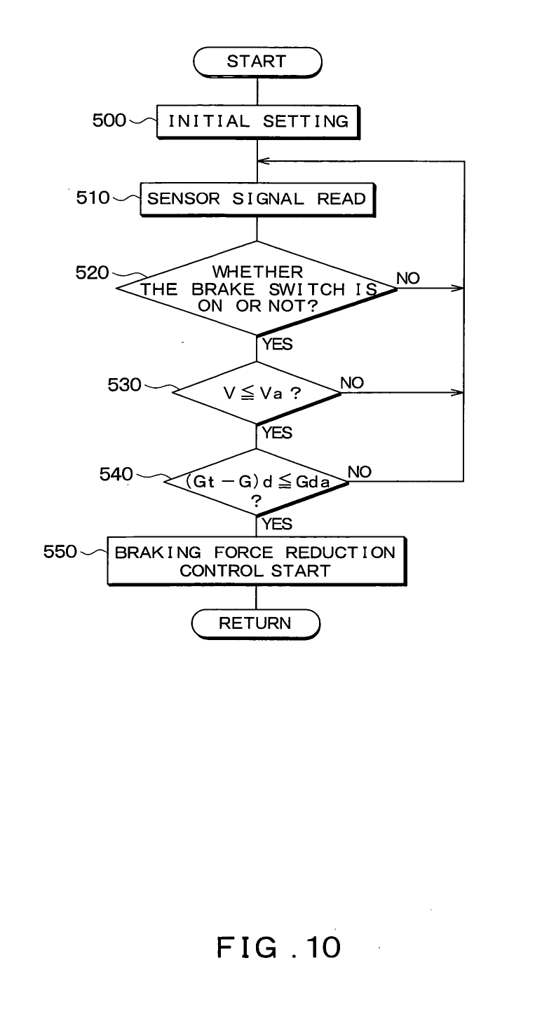

FIG. 10 is a flow chart of the braking force reduction control process performed by the brake ECU 13 provided in the vehicle brake control device 1 according to the fifth embodiment. This braking force reduction control process is repeatedly performed at a predetermined time interval when, for example, the ignition switch, not shown, is turned on.

First, in the processing at 500 to 520, the brake ECU 13 performs the same processing as at 200 to 220 of the second embodiment. Then, in the processing at 530, it is determined whether the vehicle body speed V is equal to or less than the predetermined speed Va. Note that, the predetermined speed Va is set to a value that corresponds with the method in which the vehicle body speed V is derived, in the same way as in the fourth embodiment.

Next, in the processing at 540, in the same way as in the processing at 230 in the second embodiment, it is determined whether the speed change (Gt−G)d (obtained by differentiating the difference between the estimated deceleration Gt and the actual deceleration G with respect to time) is equal to or less than the predetermined threshold value Gda. When the determination result is YES, the routine proceeds to the processing at 550 where the braking force reduction control is performed in the same manner as at 240 of the first embodiment. Note that, the routine only proceeds to the processing at 550 when the determination result is YES.

As will be clear from the above description, the braking force reduction control is only performed when the vehicle body speed V is equal to or less than the predetermined speed Va. As a result, the same effects as in the fourth embodiment can be obtained.

### Other Embodiments

(1) In the explanation of the above embodiments, the depression force sensor 12 is used to output a signal that reflects the operation amount of the brake pedal 11, which functions as the brake operating member. However, this is just one example, and a pedal stroke sensor or the like may be used instead.

(2) In the first embodiment, it is determined whether the speed change Gd of the deceleration G is equal to or less than the threshold value Gda in order to detect whether the deceleration G is tending to decrease. However, so long as the deceleration G is tending to decrease, it may be taken that the vehicle has stopped. However, the value of the deceleration G over time is derived as a varying value. Accordingly, in order to avoid operational errors caused by insignificant factors, the fact that the deceleration G is tending to decrease can be accurately detected by detecting when the speed change Gd is equal to or less that the predetermined threshold value Gda.

(3) In the example described in the above embodiments, the vehicle brake control device 1 is hydraulic, and the brake fluid pressure from the master cylinder is applied to the wheel cylinders to generate the braking force applied to the vehicle wheels 18FL to 18RR. However, this is just one example, and for example the invention may be applied to an electric brake or the like. In this case, a motor or the like is driven in accordance with depression of the brake pedal 11 to generate braking torque, which is used to apply braking force to the vehicle wheels 18FL to 18RR.

(4) In the example described in the third embodiment, the brake ECU 13 determines whether to switch to the pre-stopping braking force control or the post-stopping braking force control based on whether the driver is braking in an emergency. However, it goes without saying that the post-stopping braking force control may also be performed when the driver is braking in non-emergency situations.

(5) Note that, the processing described above in the various different routines corresponds to various units that perform the processing.

While the above description is of the preferred embodiments of the present invention, it should be appreciated that the invention may be modified, altered, or varied without deviating from the scope and fair meaning of the following claims.

What is claimed is:

1. A vehicle brake control device comprising:
a brake detection unit that detects whether the vehicle is braking;
a deceleration detection unit that detects a deceleration of the vehicle based on a detection signal from an acceleration sensor;
a speed change detection unit that derives a speed change of the deceleration detected by the deceleration detection unit; and
a braking force control unit that controls the braking force applied to a vehicle wheel provided on the vehicle, wherein.
when the vehicle brake detection unit detects that the vehicle is braking, the brake control device performs a braking force reduction control that reduces the braking force applied to the vehicle wheel by the braking force control unit, the brake control device starting the braking force reduction control when the speed change detected by the speed change detection unit is detected to have a reducing tendency.

2. The vehicle brake control device according to claim 1, wherein
the speed change detection unit derives the speed change by differentiating the deceleration detected by the deceleration detection unit with respect to time.

3. A vehicle brake control device comprising:
a brake detection unit that detects whether the vehicle is braking;
an actual deceleration detection unit that detects an actual deceleration of the vehicle based on a detection signal from an acceleration sensor;
a deceleration estimation unit that derives an estimated deceleration, which is an estimated value for the deceleration of the vehicle, based on a received signal that corresponds with an operation amount of a brake operating member used to transmit a braking request of a driver;
a speed change detection unit that derives a speed change obtained based on the difference of the estimated deceleration derived by the deceleration estimation unit and the actual deceleration detected by the actual deceleration detection unit;
a braking force control unit that controls the braking force applied to a vehicle wheel provided on the vehicle, wherein
when the brake detection unit detects that the vehicle is braking, the brake control device performs a braking force reduction control that reduces the braking force applied to the vehicle wheel by the braking force control unit, the brake control device starting the braking force reduction control when the speed change detected by the speed change detection unit is detected to have a reducing tendency.

4. The vehicle brake control device according to claim 3, wherein
the speed change detection unit derives the speed change by differentiating the difference between the estimated deceleration and the actual deceleration with respect to time.

5. The vehicle brake control device according to claim 1, further comprising:
a vehicle body speed detection unit that obtains a vehicle body speed of the vehicle, wherein
the brake control device only performs the braking force reduction control when the vehicle body speed is equal to or less than a predetermined threshold value.

6. The vehicle brake control device according to claim 3, further comprising:
a vehicle body speed detection unit that obtains a vehicle body speed of the vehicle, wherein
the brake control device only performs the braking force reduction control when the vehicle body speed is equal to or less than a predetermined threshold value.

7. The vehicle brake control device according to claim 1, further comprising:
a vehicle body speed detection unit that obtains a vehicle body speed of the vehicle; and
an emergency braking determination unit that determines whether the vehicle is braking in an emergency or non-emergency, wherein
if the emergency braking determination unit determines that the vehicle is braking in an emergency, the brake control device performs the braking force reduction control as a post-stopping braking force control, and
if the emergency braking determination unit determines that the vehicle is braking in a non-emergency situation, the brake control device performs the braking force reduction control as a pre-stopping braking force control when the vehicle body speed detected by the vehicle body speed detection unit is equal to or less than a predetermined value.

8. The vehicle brake control device according to claim 3, further comprising:
a vehicle body speed detection unit that obtains a vehicle body speed of the vehicle; and
an emergency braking determination unit that determines whether the vehicle is braking in an emergency or non-emergency, wherein
if the emergency braking determination unit determines that the vehicle is braking in an emergency, the brake control device performs the braking force reduction control as a post-stopping braking force control, and
if the emergency braking determination unit determines that the vehicle is braking in a non-emergency situation, the brake control device performs the braking force reduction control as a pre-stopping braking force control when the vehicle body speed detected by the vehicle body speed detection unit is equal to or less than a predetermined value.
